(19) United States
(12) Patent Application Publication
(10) Pub. No.: US 2015/0012229 A1
(43) Pub. Date: Jan. 8, 2015

(54) SAMPLE ANALYSIS APPARATUS, NON-TRANSITORY COMPUTER-READABLE RECORDING MEDIUM AND SAMPLE ANALYSIS METHOD

(71) Applicant: KABUSHIKI KAISHA TOSHIBA, Tokyo (JP)

(72) Inventors: Masayuki SHISHIDO, Yokkaichi-Shi (JP); Haruko AKUTSU, Yokosuka-Shi (JP)

(73) Assignee: KABUSHIKI KAISHA TOSHIBA, Tokyo (JP)

(21) Appl. No.: 14/172,616

(22) Filed: Feb. 4, 2014

(30) Foreign Application Priority Data
Jul. 2, 2013 (JP) 2013-139131

(51) Int. Cl. G01N 23/225

(52) U.S. Cl. CPC G01N 23/2252
USPC 702/32

(57) ABSTRACT

In accordance with an embodiment, a sample analysis apparatus includes an electron beam source, first and second detection units, first and second signal processing units, an X-ray path calculation unit, an X-ray detection intensity calculation unit, and a data correction unit. The electron beam source generates and applies the electron beam to a sample composed of kinds of elements. The first detection unit detects a characteristic X-ray from the sample to output a first signal. The first signal processing unit processes the first signal to acquire EDX mapping data. The second detection unit detects an HAADF signal from the sample. The second signal processing unit processes the HAADF signal to calculate the mass of the elements. The X-ray path calculation unit calculates a path of the characteristic X-ray. The X-ray detection intensity calculation unit calculates X-ray detection intensity. The data correction unit corrects the EDX mapping data.

### CROSS REFERENCE TO RELATED APPLICATIONS

This application is based upon and claims the benefit of priority from the prior Japanese Patent Application No. 2013-139131, filed on Jul. 2, 2013, the entire contents of which are incorporated herein by reference.

### FIELD

Embodiments described herein relate generally to a sample analysis apparatus, a non-transitory computer-readable recording medium and sample analysis method.

### BACKGROUND

X-ray spectroscopy (e.g. energy dispersive X-ray spectroscopy (EDX) mapping) is known as a method of identifying elements that constitute a sample. The X-ray spectroscopy applies an electron beam to the sample, and disperses by energy and detects a characteristic X-ray generated from the sample. A scanning electron microscope (SEM) which scans an observation region of the sample with a focused electron beam is known as an apparatus that enables the X-ray spectroscopy.

A scanning transmission electron microscopy (STEM) is known as another method of identifying elements that constitute a sample. According to the STEM, the sample is sliced to a degree that allows the transmission of electrons, and then placed on a stage. The transmitted electrons and the scattered electrons are detected to acquire a sample image. An image acquired by accepting the transmitted electrons in an acceptance angular range greater than the convergent angle of an incident probe among signals acquirable by an STEM apparatus is called a high-angle annular dark field (HAADF) image. The intensity of an HAADF signal is proportional to about the square of an atomic number Z per atom. Therefore, an obtained image contrast is called a Z-contrast, and elements constituting the sample can be identified by the analysis of the Z-contrast. Recently, an electron microscope capable of both the EDX mapping and the HAADF signal acquisition has been developed.

However, the X-ray spectroscopy has the disadvantage of deterioration in the accuracy of sample analysis because of a phenomenon in which part of the characteristic X-ray generated in the sample by the application of the electron beam is absorbed in a path to pass through the sample.

### BRIEF DESCRIPTION OF THE DRAWINGS

In the accompanying drawings:

FIG. 1 is a flowchart showing a general procedure of a sample analysis method according to one embodiment;

FIG. 2 is a block diagram showing a general configuration of a sample analysis apparatus according to one embodiment; and

FIG. 3 is a schematic diagram showing an example of a path of a characteristic X-ray generated in a sample.

### DETAILED DESCRIPTION

In accordance with an embodiment, a sample analysis apparatus includes an electron beam source, first and second detection units, first and second signal processing units, an X-ray path calculation unit, an X-ray detection intensity calculation unit, and a data correction unit. The electron beam source generates an electron beam and applies the electron beam to a sample composed of kinds of elements. The first detection unit detects a characteristic X-ray generated from the sample due to the application of the electron beam to output a first signal. The first signal processing unit processes the first signal to acquire EDX mapping data. The second detection unit detects an HAADF signal generated due to the transmission of the electron beam through the sample. The second signal processing unit processes the HAADF signal to calculate the mass of the elements constituting the sample from a Z-contrast image. The X-ray path calculation unit calculates a path of the characteristic X-ray from the position of the sample and the detection position of the characteristic X-ray. The X-ray detection intensity calculation unit calculates, from the mass of the elements in the calculated path, X-ray detection intensity in which the absorption amount of the characteristic X-ray in the sample is taken into consideration. The data correction unit corrects the EDX mapping data using the calculated X-ray detection intensity.

Embodiments will now be explained with reference to the accompanying drawings. Like components are provided with like reference signs throughout the drawings and repeated descriptions thereof are appropriately omitted.

(1) Sample Analysis Method

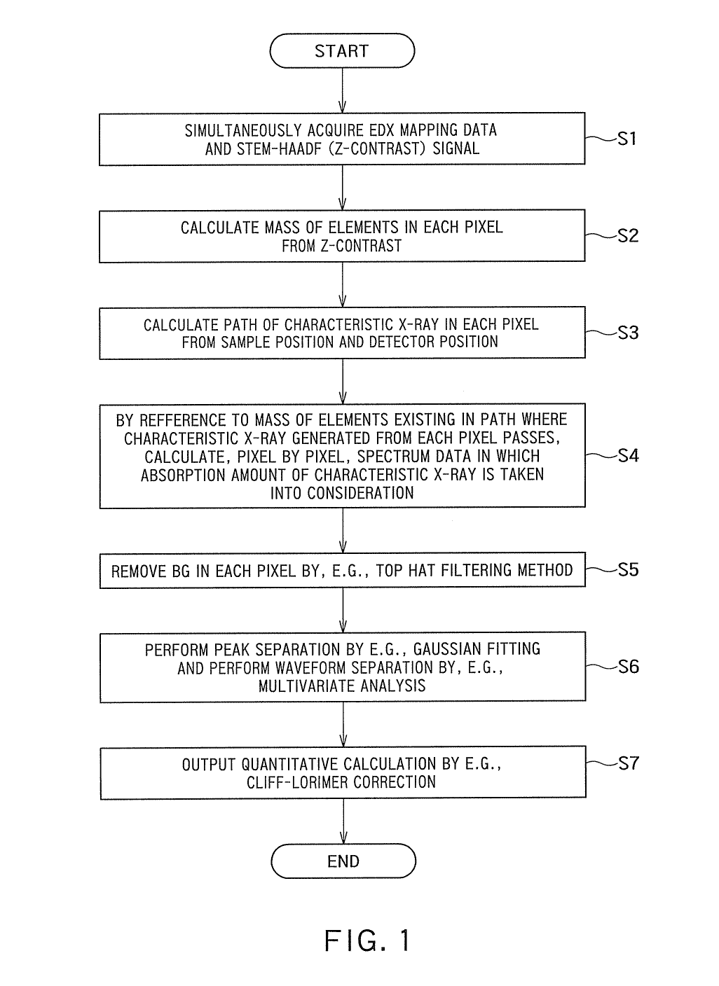

FIG. 1 is a flowchart showing a general procedure of a sample analysis method according to one embodiment.

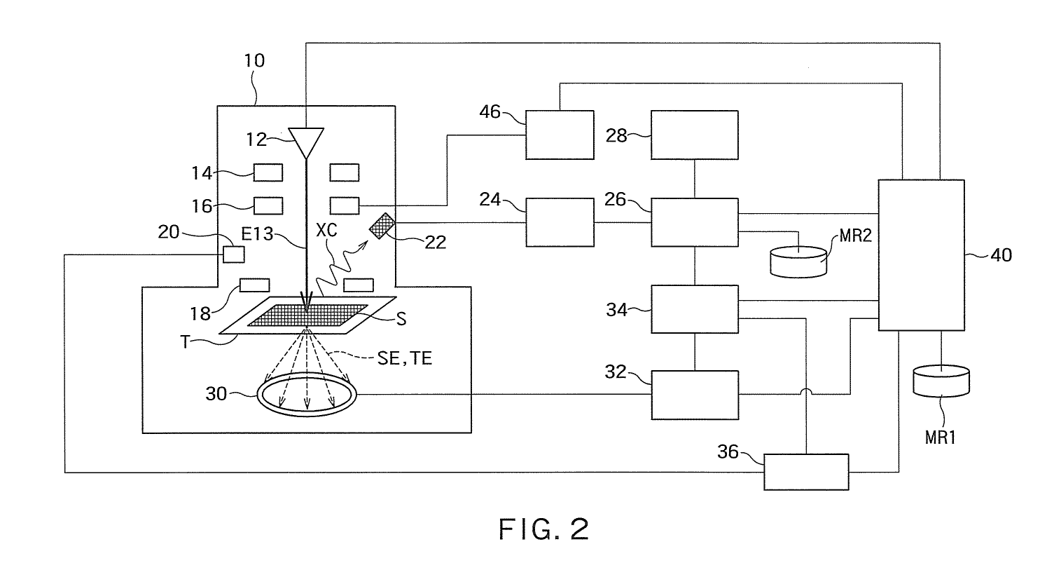

First, a sample is taken from a measurement target structure, sliced to a thickness that allows electron beam transmission, and set on a stage (see the reference sign T in FIG. 2) of an electron microscope. The electron microscope used is capable of the EDX mapping and the STEM-HAADF signal acquisition. An electron beam is then generated and focused into a probe to scan an inspection region of the sample and simultaneously acquire EDX mapping data and a STEM-HAADF signal (step S1).

The STEM-HAADF signal is proportional to about the square of an atomic number Z per atom. Therefore, an image contrast called a Z-contrast image is obtained from the STEM-HAADF signal.

The mass of elements in each pixel is then calculated from the obtained Z-contrast image (step S2).

The position of the stage of the electron microscope and the position of a detection surface to detect a characteristic X-ray are known values in each electron microscope, and can be detected in every inspection by the use of, for example, a sensor. Thus, these positional data are used to calculate, pixel by pixel, a path of the characteristic X-ray in a sample S that is generated in the sample by the entrance of the electron beam (step S3).

Detection X-ray intensity is then calculated with reference to the mass of the elements in the sample that has been calculated in step S2 and the path of the characteristic X-ray that has been calculated in step S3. The absorption of the characteristic X-ray, which is generated due to the difference of the mass of elements existing in the path of the characteristic X-ray, is taken into account in calculating the detection X-ray intensity. The EDX mapping data acquired in step S1 is corrected in accordance with the absorption amount of the characteristic X-ray incorporated in the obtained detection X-ray intensity. Spectrum data in which the absorption amount is taken into consideration is thereby calculated pixel by pixel (step S4). Specific calculation equations for this purpose will be described later in detail.

Back ground (BG) is then removed in each pixel by, for example, a top hat filtering method for the calculated spectrum data (step S5). Peak separation by Gaussian fitting, and waveform separation by multivariate analysis are performed (step S6). Further, a quantitative calculation is output by Cliff-Lorimer correction (step S7).

The absorption amount of the characteristic X-ray generated due to the inter-element mass difference is particularly greater in the combination of a heavy element and a light element, for example, the combination of a metal such as tungsten (W) and nitrogen (N) or carbon (C). The sample analysis method according to the present embodiment has a particularly significant advantage in the analysis of a sample including such composition.

According to the sample analysis method of at least one embodiment described above, the mass of a plurality of elements constituting a sample is found from an HAADF signal obtained by the transmission of an electron beam through the sample, and spectrum data in which the absorption amount of a characteristic X-ray resulting from the difference of mass between the elements is taken into consideration is calculated by reference to the mass and the path of the characteristic X-ray. Consequently, it is possible to accurately analyze the sample.

(2) Sample Analysis Apparatus

(a) Apparatus Configuration

FIG. 2 is a block diagram showing a general configuration of a sample analysis apparatus according to one embodiment. The sample analysis apparatus according to the present embodiment includes, as the main components, a controller 40, an electron beam column 10, a deflection controller 46, a characteristic X-ray signal processor 24, an HAADF signal processor 32, an X-ray detection intensity calculator 34, a path calculator 36, and an EDX corrector 26.

The electron beam column 10 includes an electron beam source 12, a condenser lens 14, a deflector 16, an objective lens 18, a stage T, a characteristic X-ray detector 22, an ADF deflector 30, and a sensor 20.

The stage T holds the sliced sample S. The electron beam source 12 generates an electron beam EB and then applies the electron beam EB to the sample S.

The controller 40 is connected to the electron beam source 12 and the deflection controller 46. The controller 40 generates control signals and sends the control signals to these components, thereby controlling the on/off of the electron beam and the intensity of the incident electron beam, and controlling the deflector 16 via the deflection controller 46. The controller 40 is also connected to a memory MR1, a path calculator 36, the HAADF signal processor 32, the EDX corrector 26, and X-ray detection intensity calculator 34.

A recipe file in which a specific procedure of the sample analysis method according to the embodiment described above is written is recorded in the memory MR1. The controller 40 reads this recipe file from the memory MR1. The controller 40 generates control signals in accordance with an inspection recipe, and supplies the control signals to the path calculator 36, the HAADF signal processor 32, and the EDX corrector 26, thereby analyzing the sample.

The characteristic X-ray detector 22 is connected to the characteristic X-ray signal processor 24. The characteristic X-ray detector 22 detects the characteristic X-ray generated from the sample S due to the application of the electron beam EB, and outputs the detection signal to the characteristic X-ray signal processor 24. In the present embodiment, the characteristic X-ray detector 22 corresponds to, for example, a first detection unit.

The characteristic X-ray signal processor 24 is connected to the EDX corrector 26. The sensor 20 is provided between the characteristic X-ray detector 22 and the stage T. The sensor 20 is connected to the path calculator 36, and the path calculator 36 is connected to the X-ray detection intensity calculator 34. The X-ray detection intensity calculator 34 is connected to the EDX corrector 26.

The ADF deflector 30 is an annular detector provided under the stage T. The ADF deflector 30 is connected to the HAADF signal processor 32, and detects scattered electrons SE and transmitted electron TE generated from the sample S due to the transmission of the electron beam EB. In the present embodiment, the ADF deflector 30 corresponds to, for example, a second detection unit. The HAADF signal processor 32 is connected to the X-ray detection intensity calculator 34.

The characteristic X-ray signal processor 24, the path calculator 36, the EDX corrector 26, and the HAADF signal processor 32 will be described below in detail in the operation of the sample analysis apparatus.

(b) Operation

The operation of the sample analysis apparatus shown in FIG. 2 is described.

First, the electron beam EB is applied to the sample S from the electron beam source 12 in accordance with an instruction signal from the controller 40. The beam flux of the electron beam EB is focused by the condenser lens 14, and the focus position of the electron beam EB is controlled by the objective lens 18 so that the electron beam EB enters the sample S in a just-focus state. During an inspection, the electron beam EB is deflected by an electric field or magnetic field generated by the deflector 16 in accordance with the control signal from the deflection controller 46. Thereby, the sample S is scanned with the electron beam EB.

A characteristic X-ray XC is generated from the sample S due to the application of the electron beam EB, and is detected by the characteristic X-ray detector 22.

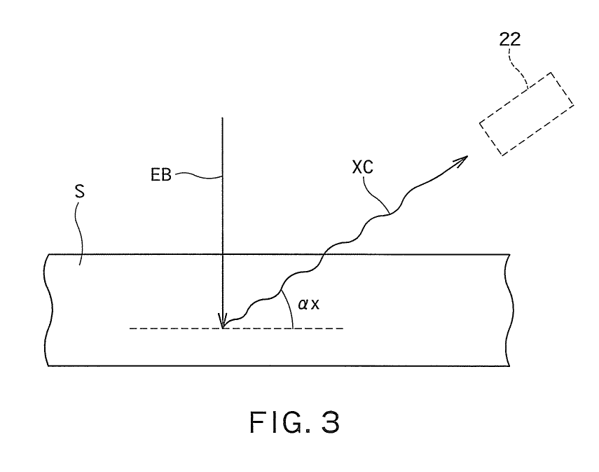

FIG. 3 is a schematic diagram illustrating a path of the characteristic X-ray XC generated in the sample S. In the example shown in FIG. 3, the electron beam EB enters the horizontally placed sample S, and the characteristic X-ray XC thereby generated departs in a direction which makes a predetermined angle αx to a horizontal surface and then travels through the sample S. After emitted from the sample S, the characteristic X-ray XC is detected by the characteristic X-ray detector 22. In the present embodiment, the angle αx corresponds to, for example, the angle between the sample and the first detection unit.

The characteristic X-ray detector 22 sends the detection signal to the characteristic X-ray signal processor 24. The characteristic X-ray signal processor 24 processes the detection signal from the characteristic X-ray detector 22 to generate the EDX mapping data, and sends the EDX mapping data to the EDX corrector 26. In the present embodiment, the characteristic X-ray signal processor 24 corresponds to, for example, a first signal processing unit.

Since the electron beam EB penetrates the sample S, the ADF deflector 30 detects the scattered electrons SE and the transmitted electron TE simultaneously with the detection of the characteristic X-ray XC. The ADF deflector 30 processes these signals to send these signals to the HAADF signal processor 32 as HAADF signals. The HAADF signal processor 32 processes the sent HAADF signal to generate a Z-contrast image. The HAADF signal processor 32 calculates the mass of the elements constituting the sample S from the Z-contrast image, and sends the calculation to the X-ray detection intensity calculator 34. In the present embodiment, the HAADF signal processor 32 corresponds to, for example, a second signal processing unit.

In the meantime, the sensor 20 detects the position of the application of the electron beam EB to the sample S, and the position of the detection surface of the characteristic X-ray detector 22, and sends the detection signal to the path calculator 36. The path calculator 36 processes the detection signal from the sensor 20 to calculate the path of the characteristic X-ray XC in the sample S, and sends the calculation to the X-ray detection intensity calculator 34. In the present embodiment, the sensor 20 corresponds to, for example, a position sensor, and the sensor 20 and the path calculator 36 correspond to, for example, an X-ray path calculation unit.

The X-ray detection intensity calculator 34 calculates detection X-ray intensity by reference to the mass of the elements in the sample S sent from the HAADF signal processor 32 and by reference to the path of the characteristic X-ray XC sent from the path calculator 36. In calculating the detection X-ray intensity, the X-ray detection intensity calculator 34 takes into consideration the absorption amount of the characteristic X-ray XC between the elements generated due to the difference of the mass of the elements existing in the path of the characteristic X-ray XC. The X-ray detection intensity calculator 34 sends the calculation result to the EDX corrector 26. In accordance with the absorption amount of the characteristic X-ray XC incorporated in the detection X-ray intensity sent from the X-ray detection intensity calculator 34, the EDX corrector 26 corrects the EDX mapping data sent from the characteristic X-ray signal processor 24. As a result, spectrum data in which the absorption of the characteristic X-ray XC between the elements is corrected is calculated pixel by pixel.

The EDX corrector 26 also removes back ground (BG) from the spectrum data pixel by pixel by, for example, the top hat filtering method, and conducts peak separation by Gaussian fitting and waveform separation by multivariate analysis. The EDX corrector 26 further performs a quantitative calculation by Cliff-Lorimer correction, and outputs the calculation result. In the present embodiment, the EDX corrector 26 corresponds to, for example, a data correction unit.

The spectrum data corrected as described above is stored and recorded in a memory MR2, and displayed by a monitor 28 so that the spectrum data can be visually recognized by an operator.

Here, the EDX mapping data obtained by the X-ray detection intensity calculator 34 is represented below in such a manner that the absorption amount between the elements is reflected.

Ideal detection X-ray intensity N, that is, detection X-ray intensity N without any absorption resulting from the mass difference between the elements can be represented by Equation (1):

N=(IσωρN₀ρCtΩε)/(4πM) Equation (1)

wherein I is incident electron beam intensity, σ is an ionization cross section, ω is a fluorescence yield, p is the generation rate of the characteristic X-ray XC of interest, N₀ is Avogadro's number, ρ is density, C is concentration (wt %), t is the thickness of the sample, Ω is a detected solid angle, ε is the detection efficiency of the characteristic X-ray detector 22, and M is atomic weight.

Here, if the characteristic X-ray XC is absorbed due to the mass difference between the elements, detection X-ray intensity N_{A} is expressed by Equation (2):

$$Equation ( 2 )$$

$$\begin{matrix}{N}_{A} = \frac{I {σ}_{A} {ω}_{A} {ρ}_{A} {N}_{0} ρ {C}_{A} t Ω ɛ}{4 π {M}_{A}} \cdot {\int }_{0}^{1} exp [ - {( \frac{μ}{ρ} )}_{A} \cdot cosec {α}_{x} \cdot ρ z ] ρ z \\ = \frac{I {σ}_{A} {ω}_{A} {ρ}_{A} {N}_{0} ρ {C}_{A} t Ω ɛ}{4 π {M}_{A}} \cdot \frac{1 - exp [ - {( \frac{μ}{ρ} )}_{A} \cdot cosec {α}_{x} \cdot ρ t ]}{[ {( \frac{μ}{ρ} )}_{A} \cdot cosec {α}_{x} \cdot ρ ]}\end{matrix}$$

wherein αx (see FIG. 2) is the angle between the sample S and the characteristic X-ray detector 22.

Equation (2) is applied when ρ is constant. When the right side of Equation (2) is F(x) and a function regarding a density distribution is represented by ρ(x), the detection X-ray intensity N is expressed by Equation (3)

N∝∫F(χ)\textcircled{×}P(χ)d_{χ} Equation (3).

The sample analysis apparatus according to at least one embodiment described above includes the HAADF signal processor 32, the X-ray detection intensity calculator 34, and the EDX corrector 26. The HAADF signal processor 32 calculates the mass of a plurality of elements constituting a sample from an HAADF signal obtained by the transmission of an electron beam through the sample. The X-ray detection intensity calculator 34 calculates X-ray detection intensity in which the absorption amount of the characteristic X-ray XC resulting from the difference of mass between the elements are taken into consideration, by reference to the mass and the path of the characteristic X-ray XC. The EDX corrector 26 uses the obtained X-ray detection intensity to correct the EDX mapping data. It is therefore possible to accurately analyze the sample.

(3) Program

A series of procedures in the sample analysis described above may be incorporated in a program, and read into and executed by a computer. This enables the accurate sample analysis described above to be carried out by use of a general-purpose computer connected to an electron microscope capable of both EDX mapping and HAADF signal acquisition.

A series of procedures of the sample analysis described above may be stored in a recording medium such as a flexible disk or a CD-ROM as a program to be executed by the computer connected to the electron microscope capable of both the EDX mapping and the HAADF signal acquisition, and read into and executed by the computer.

The recording medium is not limited to a portable medium such as a magnetic disk or an optical disk, and may be a fixed recording medium such as a hard disk drive or a memory. The program incorporating the series of procedures of the sample analysis described above may be distributed via a communication line (including wireless communication) such as the Internet.

Moreover, the program incorporating the series of procedures of the sample structure analysis described above may be distributed in an encrypted, modulated or compressed state via a wired line or a wireless line such as the Internet or in a manner stored in a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A sample analysis method comprising:
generating an electron beam and applying the electron beam to a sample composed of kinds of elements;
detecting a characteristic X-ray generated from the sample due to the application of the electron beam to acquire EDX mapping data;
detecting an HAADF signal generated due to the transmission of the electron beam through the sample;
processing the HAADF signal to generate a Z-contrast image;
calculating the mass of the elements constituting the sample from the Z-contrast image;
calculating a path of the characteristic X-ray from the position of the sample and the detection position of the characteristic X-ray; and
calculating, from the mass of the elements in the calculated path, detection X-ray intensity in which the absorption amount of the characteristic X-ray in the sample is taken into consideration.

2. The method of claim 1,
wherein the calculated X-ray detection intensity is expressed by the following equation:
$$\begin{matrix}{N}_{A} = \frac{I {σ}_{A} {ω}_{A} {ρ}_{A} {N}_{0} ρ {C}_{A} t Ω ɛ}{4 π {M}_{A}} \cdot {\int }_{0}^{1} exp [ - {( \frac{μ}{ρ} )}_{A} \cdot cosec {α}_{x} \cdot ρ z ] ρ z \\ = \frac{I {σ}_{A} {ω}_{A} {ρ}_{A} {N}_{0} ρ {C}_{A} t Ω ɛ}{4 π {M}_{A}} \cdot \frac{1 - exp [ - {( \frac{μ}{ρ} )}_{A} \cdot cosec {α}_{x} \cdot ρ t ]}{[ {( \frac{μ}{ρ} )}_{A} \cdot cosec {α}_{x} \cdot ρ ]}\end{matrix}$$
wherein I is incident electron beam intensity, σ is an ionization cross section, ω is a fluorescence yield, p is the generation rate of the characteristic X-ray XC of interest, N₀ is Avogadro's number, ρ is density, C is concentration (wt %), t is the thickness of the sample, Ω is a detected solid angle, ε is the detection efficiency of a characteristic X-ray detector, M is atomic weight, and αx is the angle between the sample and the characteristic X-ray detector.

3. The method of claim 1, further comprising
using the calculated X-ray detection intensity to correct the EDX mapping data, and thereby calculating spectrum data in which the absorption amount is taken into consideration.

4. The method of claim 3, further comprising
using a top hat filtering method to remove back ground (BG) from the calculated spectrum data.

5. The method of claim 3, further comprising
performing peak separation by Gaussian fitting for the calculated spectrum data.

6. The method of claim 3, further comprising
performing waveform separation by multivariate analysis for the calculated spectrum data.

7. The method of claim 3, further comprising
performing a quantitative calculation by Cliff-Lorimer correction for the calculated spectrum data.

8. A sample analysis apparatus comprising:
an electron beam source configured to generate an electron beam and apply the electron beam to a sample composed of kinds of elements;
a first detection unit configured to detect a characteristic X-ray generated from the sample due to the application of the electron beam to output a first signal;
a first signal processing unit configured to process the first signal to acquire EDX mapping data;
a second detection unit configured to detect an HAADF signal generated due to the transmission of the electron beam through the sample;
a second signal processing unit configured to process the HAADF signal to calculate the mass of the elements constituting the sample from a Z-contrast image;
an X-ray path calculation unit configured to calculate a path of the characteristic X-ray from the position of the sample and the detection position of the characteristic X-ray;
an X-ray detection intensity calculation unit configured to calculate, from the mass of the elements in the calculated path, X-ray detection intensity in which the absorption amount of the characteristic X-ray in the sample is taken into consideration; and
a data correction unit configured to use the calculated X-ray detection intensity to correct the EDX mapping data.

9. The apparatus of claim 8,
wherein the X-ray detection intensity calculation unit calculates the X-ray detection intensity by using the following equation:
$$\begin{matrix}{N}_{A} = \frac{I {σ}_{A} {ω}_{A} {ρ}_{A} {N}_{0} ρ {C}_{A} t Ω ɛ}{4 π {M}_{A}} \cdot {\int }_{0}^{1} exp [ - {( \frac{μ}{ρ} )}_{A} \cdot cosec {α}_{x} \cdot ρ z ] ρ z \\ = \frac{I {σ}_{A} {ω}_{A} {ρ}_{A} {N}_{0} ρ {C}_{A} t Ω ɛ}{4 π {M}_{A}} \cdot \frac{1 - exp [ - {( \frac{μ}{ρ} )}_{A} \cdot cosec {α}_{x} \cdot ρ t ]}{[ {( \frac{μ}{ρ} )}_{A} \cdot cosec {α}_{x} \cdot ρ ]}\end{matrix}$$
wherein I is incident electron beam intensity, σ is an ionization cross section, ω is a fluorescence yield, p is the generation rate of the characteristic X-ray XC of interest, N₀ is Avogadro's number, ρ is density, C is concentration (wt %), t is the thickness of the sample, Ω is a detected solid angle, ε is the detection efficiency of the first detection unit, M is atomic weight, and αx is the angle between the sample and the first detection unit.

10. The apparatus of claim 8,
wherein the data correction unit uses a top hat filtering method to remove back ground (BG) from the calculated spectrum data.

11. The apparatus of claim 8,
wherein the data correction unit performs peak separation by Gaussian fitting for the calculated spectrum data.

12. The apparatus of claim 8,
wherein the data correction unit performs waveform separation by multivariate analysis for the calculated spectrum data.

13. The apparatus of claim 8,
wherein the data correction unit performs a quantitative calculation by Cliff-Lorimer correction for the calculated spectrum data.

14. A non-transitory computer-readable recording medium storing a program which causes a computer configured to control an electron microscope to analyze a sample, the electron microscope comprising:
an electron beam source configured to generate an electron beam and apply the electron beam to a sample composed of kinds of elements;
a first detection unit configured to detect a characteristic X-ray generated from the sample due to the application of the electron beam to output a first signal;
a second detection unit configured to detect an HAADF signal generated due to the transmission of the electron beam through the sample; and a position sensor configured to detect the position of the sample and the detection position of the characteristic X-ray,
the sample analysis comprising:
generating an electron beam and applying the electron beam to a sample composed of kinds of elements;
detecting a characteristic X-ray generated from the sample due to the application of the electron beam to acquire EDX mapping data;
detecting an HAADF signal generated due to the transmission of the electron beam through the sample;
processing the HAADF signal to generate a Z-contrast image;
calculating the mass of the elements constituting the sample from the Z-contrast image;
calculating a path of the characteristic X-ray from the position of the sample and the detection position of the characteristic X-ray; and
calculating, from the mass of the elements in the calculated path, detection X-ray intensity in which the absorption amount of the characteristic X-ray in the sample is taken into consideration.

15. The medium of claim 14,
wherein the calculated X-ray detection intensity is expressed by the following equation:
$$\begin{matrix}{N}_{A} = \frac{I {σ}_{A} {ω}_{A} {ρ}_{A} {N}_{0} ρ {C}_{A} t Ω ɛ}{4 π {M}_{A}} \cdot {\int }_{0}^{1} exp [ - {( \frac{μ}{ρ} )}_{A} \cdot cosec {α}_{x} \cdot ρ z ] ρ z \\ = \frac{I {σ}_{A} {ω}_{A} {ρ}_{A} {N}_{0} ρ {C}_{A} t Ω ɛ}{4 π {M}_{A}} \cdot \frac{1 - exp [ - {( \frac{μ}{ρ} )}_{A} \cdot cosec {α}_{x} \cdot ρ t ]}{[ {( \frac{μ}{ρ} )}_{A} \cdot cosec {α}_{x} \cdot ρ ]}\end{matrix}$$
wherein I is incident electron beam intensity, σ is an ionization cross section, ω is a fluorescence yield, p is the generation rate of the characteristic X-ray XC of interest, N₀ is Avogadro's number, ρ is density, C is concentration (wt %), t is the thickness of the sample, Ω is a detected solid angle, ε is the detection efficiency of a characteristic X-ray detector, M is atomic weight, and αx is the angle between the sample and the characteristic X-ray detector.

16. The medium of claim 14,
wherein the sample analysis further comprises using the calculated X-ray detection intensity to correct the EDX mapping data, and thereby calculating spectrum data in which the absorption amount is taken into consideration.

17. The medium of claim 16,
wherein the sample analysis further comprises using a top hat filtering method to remove back ground (BG) from the calculated spectrum data.

18. The medium of claim 16,
wherein the sample analysis further comprises performing peak separation by Gaussian fitting for the calculated spectrum data.

19. The medium of claim 16,
wherein the sample analysis further comprises performing waveform separation by multivariate analysis for the calculated spectrum data.

20. The medium of claim 16,
wherein the sample analysis further comprises performing a quantitative calculation by Cliff-Lorimer correction for the calculated spectrum data.
